(19) United States
(12) Patent Application Publication
(10) Pub. No.: US 2026/0048391 A1
(43) Pub. Date: Feb. 19, 2026

(54) POINT-OF-CARE TESTING DEVICE FOR QUANTITATIVE SAMPLING OF LIQUID BIO-ANALYTES

(71) Applicant: GENBODY INC., Cheonan-si, Chungcheongnam-do (KR)

(72) Inventors: Chomkyu CHONG, Cheonan-si, Chungcheongnam-do (KR); Joungdae MOON, Cheonan-si, Chungcheongnam-do (KR); Jongpil PARK, Sejong-si (KR); Yang Hwa HA, Cheonan-si, Chungcheongnam-do (KR); Eun Sung JEON, Cheonan-si, Chungcheongnam-do (KR); Jun-Won YOO, Gwangmyeong-si, Gyeonggi-do (KR)

(21) Appl. No.: 19/102,623

(22) PCT Filed: Dec. 27, 2022
(86) PCT No.: PCT/KR2022/021356

§ 371 Date: Feb. 10, 2025

(30) Foreign Application Priority Data
Nov. 2, 2022 (KR) 10-2022-0144753

(51) Int. Cl. B01L 3/00

(52) U.S. Cl. CPC B01L 3/5023; B01L 2200/0684; B01L 2200/16; B01L 2300/042; B01L 2300/0825; B01L 2300/0832

(57) ABSTRACT

Provided is a point-of-care testing device including a tubular body (10); a cap (12) mounted on an upper end of the body (10) and configured to move along a lengthwise direction of the body (10); a test strip (13) spaced apart from an inner bottom surface of the body (10) by a tolerance (d) and configured to move inside the body (10) as the cap (12) is press-fitted into the body (10); a collecting portion (11) protruding from a lower end of the body (10) downward and being in fluid communication with the body (10); and a reagent tube (14) formed so that at least a part of the body (10) is inserted therein and at least a part of a bottom surface of the reagent tube (14) has a flat surface.

### TECHNICAL FIELD

The present disclosure relates to a device for testing liquid bio-analytes, and more particularly, to a point-of-care testing device for quantitative sampling of liquid bio-analytes in which a quantitative amount of bio-analytes can be collected and tested by using a simple operation method so that user convenience can be considered.

### BACKGROUND ART

Contents described in this section merely provide background information on the present disclosure but do not constitute prior art.

In vitro diagnostics technology, in which samples such as blood, saliva, and nasal mucus or the like are collected from the human body and then health status and the presence or absence of disease is diagnosed by using the collected samples, has been highly developed and has been used in many technical fields. For example, sample collection from the human body may be performed using a cotton swab, and more specifically, when nasal mucus is collected, nasal mucus is collected from deep in the nasal cavity by inserting a sample collection swab into the nasal cavity.

In the case of a diagnostic kit for rapid testing using blood, it is difficult to perform quantitative collection of blood. Thus, a separate instrument capable of measuring the volume is required for quantitative collection.

In addition, even though a quantitative amount of reagent needs to be administered in a reagent inlet, less or more than the quantitative amount of reagent is administered, and as a result, a misdiagnosis rate is high.

In addition, a variety of materials are required depending on collection, volume diagnosis, and the use of a pipette for reagent input so that waste products increase. In particular, a general test container includes a shape (e.g., a round shape) in which a lower surface of the test container cannot stand on the ground so that accessories such as a stand to stand up the test container are essential.

In addition, in the case of analyte collection and test instruments according to the related art, there is no mechanical locking device that can prevent reuse, and the misdiagnosis rate increases due to reuse.

(Patent Document 1) Kr 10-2014-0094931 A

(Patent Document 2) U.S. Pat. No. 7,959,877 B2

### DETAILED DESCRIPTION OF THE INVENTION

### Technical Problem

Accordingly, the present disclosure provides a point-of-care testing device capable of collecting a quantitative amount.

The present disclosure also provides a point-of-care testing device capable of collecting and testing analytes by itself without requiring accessories.

The present disclosure also provides a point-of-care testing device capable of preventing reuse during analyte collection and testing.

The problems to be solved by the present disclosure are not limited to the problems mentioned above, and other tasks not mentioned will become clear to those skilled in the art from the description below.

### Technical Solution

According to an aspect of the present disclosure, the present disclosure provides a point-of-care testing device includes: a tubular body (10); a cap (12) mounted on an upper end of the body (10) and configured to move along a lengthwise direction of the body (10); a test strip (13) spaced apart from an inner bottom surface of the body (10) by a tolerance (d) and configured to move inside the body (10) as the cap (12) is press-fitted into the body (10); a collecting portion (11) protruding from a lower end of the body (10) downward and being in fluid communication with the body (10); and a reagent tube (14) formed so that at least a part of the body (10) is inserted therein and at least a part of a bottom surface of the reagent tube (14) has a flat surface.

Additionally, the body (10) preferably includes locking protrusions (100) protruding from one side of the body (10) outward, and the cap (12) may include a first locking hole (120) through which the locking protrusions (100) are supported, a second locking hole (122) formed above the first locking hole (120), and a connection hole (124) connecting the first locking hole (120) and the second locking hole (122) to each other and formed on one side of the cap (12), respectively.

Additionally, the point-of-care testing device is preferably in one state of a first state in which the locking protrusions (100) are disposed in the first locking hole (120); and a second state in which the locking protrusions (100) are disposed in the second locking hole (122) due to press-fitting of the cap (12), and in the first state, an inner space is formed between an upper surface of the body (10) and the cap (12), and the inner space between the upper surface of the body (10) and the cap (12) is compressed in the second state, and when the point-of-care testing device changes from the first state to the second state, air in the inner space is discharged through vent holes (102) formed in one side of the body (10).

Additionally, a length of the tolerance (d) from an inner bottom surface of the body (10) to a lower end surface of the test strip (13) in the first state is preferably equal to a distance from an upper surface of the body (10) to an inner surface of the cap (12).

Additionally, an inclined surface (104) is preferably formed on an inner front surface and an inner rear surface of the body (10) to protrude toward an inside of the body (10) from an inner side surface and extends along a lengthwise direction of the body (10), and a protruding width of the inclined surface (104) may be formed so that it becomes larger as it goes downward.

Additionally, the body (10) preferably includes a pressing protrusion (106) that is formed at one or more of the inner front surface and the inner rear surface, protrudes from the inner side surface toward an inside of the body (10) and is configured to press the test strip (13).

Additionally, guide grooves are preferably formed on an upper end of the body (10) and recessed into an outer front or outer rear surface of the body (10) inwards, and guide protrusions are formed on a lower end of the cap (12) and protrude from the inner front or inner rear surface of the cap (12) inwards, and the guide protrusions are disposed in the guide grooves.

According to another aspect of the present disclosure, the present disclosure provides a method using the point-of-care testing device according to the present disclosure, includes: (a) collecting an analyte by contacting an analyte with a lower end of a body; (b) inserting the body into a reagent tube standing upright from a ground; and (c) press-fitting the cap in a state in which the body is inserted into the reagent tube.

### DESCRIPTION OF THE DRAWINGS

FIG. 1 is a perspective view of a point-of-care testing device according to an embodiment of the present disclosure;

FIG. 2 is an exploded perspective view of a point-of-care testing device according to an embodiment of the present disclosure;

FIG. 3 is a view for describing the operation of a point-of-care testing device according to an embodiment of the present disclosure;

FIGS. 4 and 5 are cross-sectional views of a body taken along a yz-plane, according to an embodiment of the present disclosure;

FIG. 6 is a view for describing the operation of a point-of-care testing device according to an embodiment of the present disclosure; and

FIG. 7 is a flowchart illustrating a method using a point-of-care testing device according to an embodiment of the present disclosure.

### MODE OF THE INVENTION

Hereinafter, some embodiments of the present disclosure will be described in detail through exemplary drawings. In adding reference numerals to components of each drawing, it should be noted that the same components have the same numerals as much as possible, even if they are indicated on different drawings. In addition, in describing the present disclosure, if it is determined that a detailed description of a related known configuration or function may obscure the gist of the present disclosure, the detailed description will be omitted.

In explaining components of embodiments of the present disclosure, symbols such as first, second, i), ii), a), b), and the like may be used. Symbols are only used to distinguish one component from another component, but the nature, order, or sequence of components is not limited by the symbols. When a part is defined as “including” or “having” a component in the specification, it indicates that the part does not exclude another component, but instead includes another component unless it explicitly states otherwise.

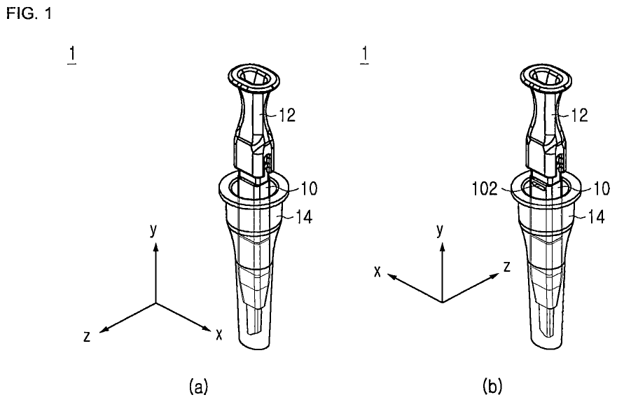

In the present disclosure, “upward side” means the positive direction of the y-axis in FIG. 1. In addition, “right side” means the positive direction of the x-axis in FIG. 1. In addition, “forward”means the positive direction of the z-axis in FIG. 1.

In addition, in the present disclosure, “width” means the length of a side in a direction parallel to the x-axis. In addition, “length” means the length of a side in a direction parallel to the z-axis. In addition, “height” means the length of a side in a direction parallel to the y-axis.

In addition, in the present disclosure, “analyte” corresponds to blood or bodily fluid collected from the body of a subject, and illustratively, blood, saliva, nasal mucus, etc.

In addition, in the present disclosure, “reagent” means a liquid that is mixed with the analyte, dilutes the analyte and is used to develop the analyte.

In addition, in the present disclosure, “solution” means a liquid in which an analyte and a reagent are mixed together.

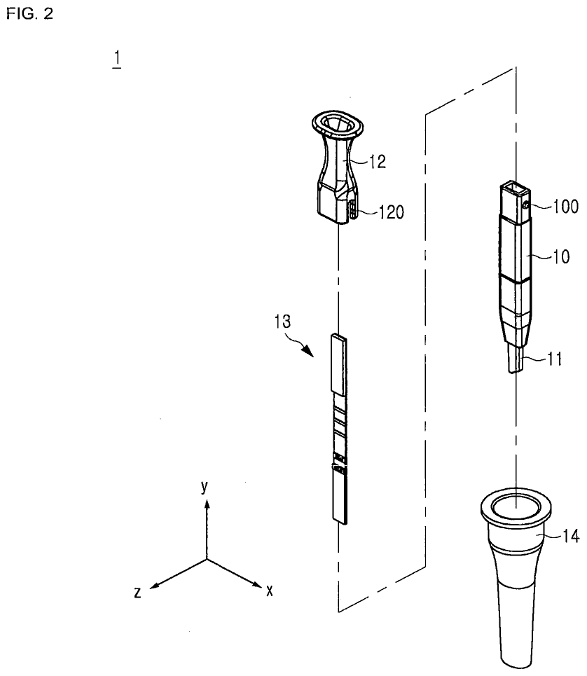

FIG. 1 is a perspective view of a point-of-care testing device according to an embodiment of the present disclosure. FIG. 2 is an exploded perspective view of a point-of-care testing device according to an embodiment of the present disclosure.

Referring to FIGS. 1 and 2, a point-of-care testing device (1) according to an embodiment of the present disclosure includes a body (10), a cap (12), a test strip (13), and all or part of a reagent tube (14).

The body (10) is formed in a substantially hollow columnar shape and is formed so that the test strip (13) is disposed inside the body (10). The body (10) may have a cylindrical or polygonal column shape, and the shape of the body (10) may be selected properly.

The body (10) is formed to surround at least a part of the test strip (13) so as to protect the test strip (13) from external contaminants and damage. Preferably, at least a part of the body (10) may be transparent so that the result of the test strip (13) can be confirmed with the naked eye. To this end, the body (10) may be formed of a hard material capable of transparent injection. At this time, the material of the body (10) may preferably be polyester (PE) or polystyrene (PS).

It is preferable that a hollow having sufficient width, length and height is formed inside the body (10) so that the movement of the test strip (13) is not constrained by the inner wall surface of the body (10) when the test strip (13) moves inside the body (10). At this time, the vertical length of the hollow of the body (10) may be 1 mm to 2 mm, and the horizontal length of the hollow may be 4 mm, and the height of the hollow may be 60 mm. However, the above figures are only examples, and it will be noted that the number may be appropriately selected according to the type of analyte to be collected and the type of reagent.

Locking protrusions (100) may be formed on a left side or right side of the vicinity where the body (10) and the cap (12) are coupled to each other. The locking protrusions (100) may protrude from the right side or left side of the body (10) outward and may be caught on the cap (12). Meanwhile, in the present disclosure, the protrusions (100) are formed on both left and right sides of the body (10), but the present disclosure is not necessarily limited thereto.

Guide grooves (not shown) may be formed on the inner front or inner rear surface of the vicinity where the body (10) and the cap (12) are coupled to each other. In addition, guide protrusions (not shown) may be formed on the inner front or inner rear surface of the cap (12). Guide protrusions are disposed in the guide grooves so that the cap (12) can move along the guide grooves.

A collecting portion (11) may be formed at the lower end of the body (10). An analyte flows into the body (10) through the collecting portion (11). To this end, a hollow is formed inside the collecting portion (11), and the hollow inside the body (10) and the hollow inside the collecting portion (11) are in fluid communication with each other.

It is preferable that the horizontal length of the hollow formed inside the collecting portion (11) is smaller than the horizontal length of the test strip (13). Thus, the test strip (13) may pass through the collecting portion (11) and may not escape to the outside.

The vertical length of the hollow formed inside the collecting portion (11) may be 0.3 mm to 0.5 mm. In other words, the hollow of the collecting portion (11) is in the form of a thin plate so that analytes and reagents can be collected in the body (10) by capillary action. Meanwhile, the volume of the hollow inside the collecting portion (11) may be between 5 μL and 40 μL. For example, in order to take out 10 μL of a reagent, the vertical length of the hollow may be 0.5 mm, the length may be 2 mm, and the height may be 10 mm. Meanwhile, these figures are only examples, and it is noted that these figures can be properly changed considering the appropriate volume of an analyte and a reagent.

To collect water-soluble reagents, the inside of the collecting portion (11) is coated with a hydrophilic material, or the collecting portion (11) of the hydrophilic material may be separately manufactured and attached to the body (10). At this time, the hydrophilic material is a material in which, for example, Tween20 is diluted in water to a predetermined concentration.

One or more vent holes (102) may be formed on one side of the body (10). At this time, the location of the vent holes (102) may be a location where, in a state in which the cap (12) moves downward to the maximum along the body (10), the vent holes (102) are formed in a position that is not covered. Air inside the body (10) may be discharged to the outside through the vent holes (102). The content, in which air is discharged through the vent holes (102), will be described in detail in FIG. 5.

The cap (12) is formed to be mounted on the top of the body (10). At this time, an upper end of the body (10) may be inserted into the cap (12).

Additionally, the cap (12) is formed so that the test strip (13) is fixed therein. Thus, the test strip (13) may move together depending on the movement of the cap (12).

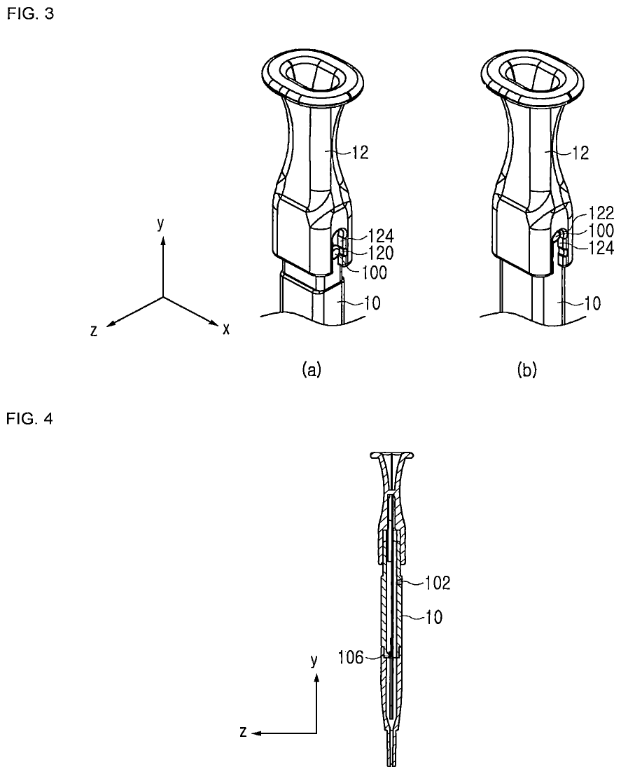

One or more locking holes (120) and (122) are formed on the left or right side of the cap (12). One or more locking holes (see 120 and 122 of FIG. 3) includes a first locking hole (120) formed on one side and a second locking hole (122) formed above the first locking hole (120). The locking protrusions (100) may be caught in the first locking hole (120) or the second locking hole (122).

Additionally, a connection hole (see 124 of FIG. 3) configured to connect the first locking hole (120) and the second locking hole (122) to each other may be formed between the first locking hole (120) and the second locking hole (122). At this time, the connection hole (124) may be formed to have a smaller width than the maximum inner diameter of the locking holes (120 and 122). In this regard, this will be described in detail in FIG. 3.

The test strip (13) is configured to move downward according to the movement of the cap (12) while being inserted into the body (10).

When the lower end of the test strip (13) comes into contact with the analyte and the reagent, analytes and reagents move upward along the test strip (13) and react with a chromogenic part. The type of virus to which the chromogenic part reacts may be, for example, HIV, Dengue, Malaria, etc., but the type of virus to be tested may be appropriately changed according to the target to be tested.

The test strip (13) may be in the form of overlapping several pads coated with different types of reactants. In other words, various diagnoses may be possible with one test strip (13).

The reagent tube (14) is formed so that the body (10) is inserted therein, and has a substantially container shape. The reagent tube (14) is manufactured in a state in which a reagent is contained on the inner bottom surface, and is sealed and stored.

A reagent is applied to the inside of the reagent tube (14) in a production step. At this time, preferably, a larger amount of reagents than the reagent required for actual development may be provided. This is because the possibility of misdiagnosis due to the occurrence of dead volume cannot be excluded when the viscosity of the reagent and the analyte is high. If the test strip (13) according to one embodiment is a strip for HIV test, the reagent in an amount of about 100 μL is required to obtain a normal result, and it is preferable that 200 μL of the reagent is provided in the reagent tube (14) considering the dead volume.

FIG. 3 is a view for explaining the operation of a point-of-care testing device according to an embodiment of the present disclosure.

(a) of FIG. 3 shows a state in which the locking protrusions (100) are disposed in the first locking hole (120). Hereinafter, this state of the point-of-care testing device (1) according to an embodiment of the present disclosure is referred to as a “first state”.

(b) of FIG. 3 shows a state in which the locking protrusions (100) are disposed in the second locking hole (122). Hereinafter, this state of the point-of-care testing device (1) according to an embodiment of the present disclosure is referred to as a “second state”.

The connection hole (124) is formed to guide the movement of the locking protrusions (100) between the first locking hole (120) and the second locking hole (122). In other words, when the point-of-care testing device (1) changes its state from the first state to the second state, the locking protrusions (100) may move naturally along the connection hole (124).

Referring to FIG. 3, preferably, the locking protrusions (100) are formed in a cylindrical shape, and the first locking hole (120) and the second locking hole (122) preferably have a shape corresponding to the shape of the outer circumferential surface of the locking protrusions (100). In addition, the width of the connection hole (124) may preferably be smaller than the inside diameter of the locking holes (120 and 122) or the diameter of the locking protrusions (100). Thus, the cap (12) may be prevented from unnaturally moving upward. In other words, when the state of the point-of-care testing device (1) is changed from the first state to the second state, it is performed by the user's pressing force so that, even if the diameter of the connection hole (124) is formed small, the state can be changed according to the user's will. However, in the opposite case, when the state of the point-of-care testing device (1) is changed from the second state to the first state, it may be prevented due to the narrow width of the connection hole (124), and thus, there is the effect of preventing reuse.

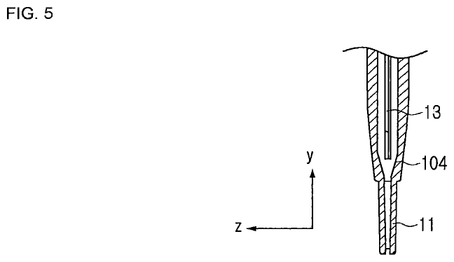

FIGS. 4 and 5 are cross-sectional views of a body taken along an yz-plane, according to an embodiment of the present disclosure.

Referring to FIG. 4, a pressing protrusion (106) protruding toward the inside of the body (10) may be disposed on the inner side of the body (10). The test strip (13) is generally formed by overlapping several pads. Because the pressing protrusion (106) presses the test strip (13) with a certain pressure, it may help with sample development.

Additionally, the body (10) is injection molded into two pieces, respectively, and may be produced in a way that is later assembled. Thus, a complex shape inside the body (10) can be realized, and this can be advantageous for mass production. However, it is noted that the manufacture method of the body (10) according to the present disclosure may be appropriately selected.

Referring to FIG. 5, the body (10) includes an inclined surface (104). The inclined surface (104) protrudes toward the inside of the body (10) from the inner front surface and/or the inner rear surface. Additionally, the protruding width of the inclined surface (104) is formed so that it becomes larger as it goes downward.

When the test strip (13) moves downward, the lower end of the test strip (13) may be guided in an appropriate direction while moving along the inclined surface (104). The test strip (13) is a strip with a longer length than the width, and except that the upper part of the test strip (13) is fixed, there is no separate fixing device, and when moving downward, the test strip (13) may move left and right or back and forth. In this case, the test strip (13) is not properly placed in the collecting portion (11), and the solution may not be developed along the test strip (13). At this time, when the inclined surface (104) is provided, even if the test strip (13) shakes while moving, there is an effect of being guided toward the collecting portion (11) by the inclined surface (104).

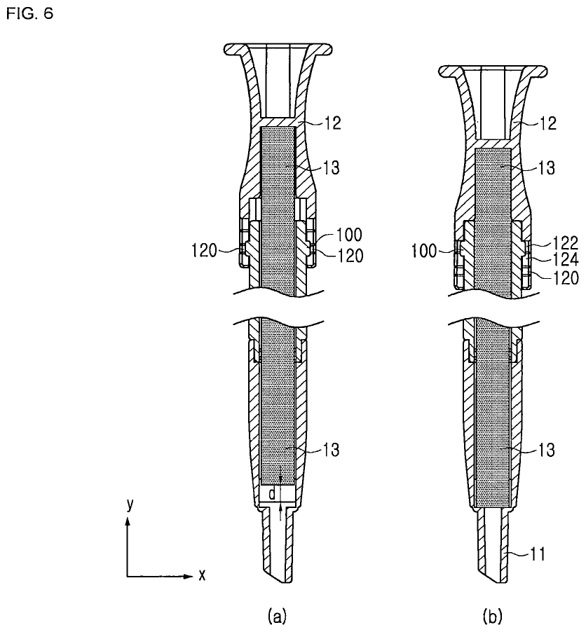

FIG. 6 is a view for explaining the operation of a point-of-care test device according to an embodiment of the present disclosure.

(a) of FIG. 6 shows a state before the body (10) is inserted into the reagent tube (14), and (b) of FIG. 6 shows a state after the body (10) is inserted into the reagent tube (14), the cap (12) is press-fitted.

Referring to (a) of FIG. 6, before the body (10) in the first state is inserted into the reagent tube (14), the locking protrusions (100) are caught in the first locking hole (120). Additionally, the lower end of the test strip (13) is spaced apart from the inner bottom surface of the body (10) by a certain tolerance d. An analyte may be collected in the body 10 as much as the inner space formed by the tolerance (d). Meanwhile, the value of the tolerance (d) itself may be appropriately designed by a designer, but it is determined at the time of manufacture, and thus, a quantitative amount of an analyte may be collected into the body (10). Accordingly, there is an advantage in that a separate tool (e.g., a pipette) for measuring the volume of an analyte is not required.

Referring (b) of FIG. 6, in the second state, the body (10) is inserted into the reagent tube (14), and the cap (12) is press-fitted downward by the user. The locking protrusions (100) move along the connection hole (124) and is disposed in the second locking hole (122). At this time, a distance between the center of the first locking hole (120) and the center of the second locking hole (122) may be spaced apart as much as the tolerance (d).

An inner space formed between the upper surface of the body (10) and the cap (12) is reduced due to the downward movement of the cap (12). As the volume of the air staying in the above internal space decreases, the pressure increases. Due to the increased pressure, there is a risk that the analyte remaining in the collecting portion (11) escapes. At this time, air is discharged through a vent hole (see 102 of FIG. 1) formed on one side of the body (10) and the pressure inside the body (10) is maintained so that the loss of an analyte can be prevented.

Additionally, the effect that the cap (12) is press-fitted downward without a sense of resistance so that soft feeling of use may be provided to the user.

As the cap (12) moves, the test strip (13) moves downward by the tolerance (d), and the lower end of the test strip (13) is seated on the interface between the collecting portion (11) and the body (10). At this time, the reagent disposed in the reagent tube (14) flows into the body (10) through the collecting portion (11). The reagent is introduced into the body (10) and the analyte and the reagent are mixed to form a solution, and volume increases. At this time, as the inner space formed by the tolerance (d) is compressed, the solution naturally moves upward along the test strip (13).

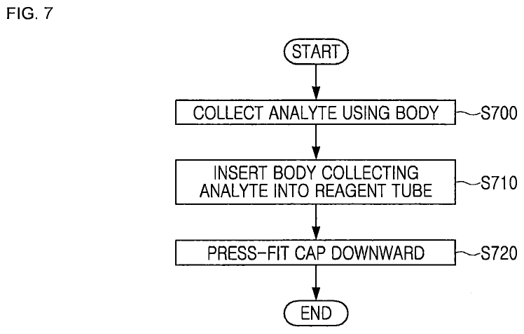

FIG. 7 is a flowchart of a method using a point-of-care testing device according to an embodiment of the present disclosure.

FIG. 7 is a flowchart of a method using an analyte collection device according to an embodiment of the present disclosure.

Referring to FIG. 7, the method using the analyte collection device according to an embodiment of the present disclosure includes collecting the analyte by contacting the analyte with the lower end of the body 10 (S700). At this time, the analyte may exemplarily be blood and will naturally be sucked up by the capillary action and the pressure difference along the minute gap of the collecting portion (11). The analyte introduced into the body (10) through the collecting portion (11) is temporarily stored in the internal space of the body (10) formed by the tolerance (d).

Subsequently, the body (10) collecting the analyte is inserted into the reagent tube (14) by the user (S710). At this time, because the reagent tube (14) has a flat outer bottom surface, the reagent tube (14) may stand without a separate device such as a stand. Of course, it is irrelevant even if a stand is further provided for stable fixation.

In a state where the body (10) is inserted into the reagent tube (14), the cap (12) is press-fitted downward by the user (S720).

As the cap (12) is press-fitted, the test strip (13) also moves downward. Thus, the internal space of the body (10) formed by the tolerance (d) is compressed (see FIG. 6), and the analyte staying in the body (10) and the collecting portion (11) may partially move along the test strip (13). At the same time, the reagent outside the body (10) and provided on the inner bottom surface of the reagent tube (14) is collected by the collecting portion (11) and flows into the inside of the body (10). The analyte and reagent are mixed to form a solution, and the solution may be developed upward along the test strip (13).

Meanwhile, according to the press-fit of the cap (12), the inner space of the cap (12) formed between the cap (12) and the upper end of the body (10) is also compressed (see FIG. 6). At this time, air staying in the inner space of the cap (12) may be discharged to the outside through the vent hole (102) of the body (10).

The above description is merely an example of the technical idea of the present embodiment, and various modifications and variations can be made to those skilled in the art without departing from the essential characteristics of the present embodiment. Therefore, the present embodiments are not intended to limit the technical idea of the present embodiment, but to explain, and the scope of the technical idea of the present embodiment is not limited by these embodiments. The scope of protection of this embodiment should be interpreted according to the claims below, and all technical ideas within the scope equivalent thereto should be construed as being included in the scope of rights of this embodiment.

### EXPLANATION OF REFERENCE NUMERALS

1: point-of-care testing device
10: body
100: locking protrusions
102: vent holes
104: inclined surface
106: pressing protrusion
11: collecting portion
12: cap
120: first locking hole
122: second locking hole
124: connection hole
13: test strip
14: reagent tube

1. A point-of-care testing device comprising:
a tubular body;
a cap mounted on an upper end of the body and configured to move along a lengthwise direction of the body;
a test strip spaced apart from an inner bottom surface of the body by a tolerance and configured to move inside the body as the cap is press-fitted into the body;
a collecting portion protruding from a lower end of the body downward and being in fluid communication with the body; and
a reagent tube formed so that at least a part of the body is inserted therein and at least a part of a bottom surface of the reagent tube has a flat surface.

2. The point-of-care testing device of claim 1, wherein the body comprises locking protrusions protruding from one side of the body outward, and the cap comprises a first locking hole through which the locking protrusions are supported, a second locking hole formed above the first locking hole, and a connection hole connecting the first locking hole and the second locking hole to each other and formed on one side of the cap, respectively.

3. The point-of-care testing device of claim 2, wherein the point-of-care testing device is in one state of a first state in which the locking protrusions are disposed in the first locking hole; or
a second state in which the locking protrusions are disposed in the second locking hole due to press-fitting of the cap, and
in the first state, an inner space is formed between an upper surface of the body and the cap, and the inner space between the upper surface of the body and the cap is compressed in the second state, and when the point-of-care testing device changes from the first state to the second state, air in the inner space is discharged through vent holes formed in one side of the body.

4. The point-of-care testing device of claim 3, wherein a length of the tolerance (d) from an inner bottom surface of the body to a lower end surface of the test strip in the first state is equal to a distance from an upper surface of the body to an inner surface of the cap.

5. The point-of-care testing device of claim 1, wherein an inclined surface is formed on an inner front surface and an inner rear surface of the body to protrude toward an inside of the body from an inner side surface and extends along a lengthwise direction of the body, and a protruding width of the inclined surface is formed so that it becomes larger as it goes downward.

6. The point-of-care testing device of claim 1, wherein the body comprises a pressing protrusion that is formed at one or more of the inner front surface and the inner rear surface, protrudes from the inner side surface toward an inside of the body, and is configured to press the test strip.

7. The point-of-care testing device of claim 1, wherein guide grooves are formed on an upper end of the body and recessed into an outer front or outer rear surface of the body inwards, and guide protrusions are formed on a lower end of the cap and protrude from the inner front or inner rear surface of the cap inwards, and the guide protrusions are disposed in the guide grooves.

8. A method using the point-of-care testing device of claim 1, the method comprising:
(a) collecting an analyte by contacting an analyte with a lower end of a body;
(b) inserting the body into a reagent tube standing upright from a ground; and
(c) press-fitting the cap in a state in which the body is inserted into the reagent tube.
